(19) United States
(12) Patent Application Publication
(10) Pub. No.: US 2021/0116148 A1
(43) Pub. Date: Apr. 22, 2021

(54) Hot Air Blower

(71) Applicant: Paseco Co., Ltd., Ansan-si (KR)

(72) Inventor: Jae Seok Kwak, Siheung-si (KR)

(21) Appl. No.: 16/720,990

(22) Filed: Dec. 19, 2019

(30) Foreign Application Priority Data
Oct. 18, 2019 (KR) 10-2019-0129757

(51) Int. Cl. F24H 3/04; F23N 3/02; F24H 9/18

(52) U.S. Cl. CPC F24H 3/0488; F24H 9/1881; F23N 3/02

(57) ABSTRACT

A hot air blower includes a fuel tank, an air compression pump for compressing air, a pressure regulating valve to decompress the compressed air. The hot air blower also includes a burner assembly and a combustion chamber for receiving fuel from the burner assembly to combust the fuel. The pressure regulating valve includes a high-pressure pressure regulating valve and a low-pressure pressure regulating valve. The low-pressure pressure regulating valve is provided with a low pressure valve opening and closing unit. The low pressure valve opening and closing unit includes a valve body installed communicating with a low pressure discharge port and having an inlet formed in the center of the front portion thereof to communicate with the low pressure discharge port, an outlet formed in the side surface thereof and communicating with the inlet, and an accommodation hole formed therein and communicating with both the inlet and the outlet.

### BACKGROUND OF THE INVENTION

### Cross-Reference to Related Application

This application claims the benefit of Korean Patent Application No. 10-2019-0129757, filed Oct. 18, 2019.

### FIELD OF THE INVENTION

The present invention relates to a hot air blower and, more specifically, to a hot air blower having pressure regulating valves that can finely regulate the air pressure to be supplied to a burner.

### BACKGROUND ART

In general, a hot air blower is used for heating or dehumidifying the interior of a factory, a green house, a barn, or the like.

Such a hot air blower uses a heat transfer method of heating sucked gas to a high temperature by applying power to a heater or a heating wire consisting of a coil and then supplying the gas by using a blower fan, or a combustion heating method of burning fuel in a combustion chamber and supplying the high-temperature combustion heat by using a blower fan.

FIG. 1 to FIG. 3 illustrate a typical example of such a hot air blower employing the combustion heating method.

As illustrated, a combustion heating type hot air blower includes a hot air blower main body 10 having a fuel tank 12 provided at the lower portion thereof, a combustion chamber 20 provided in the front portion of the hot air blower main body 10 at the upper portion of the fuel tank 12, a burner assembly 22 installed at the rear portion of the combustion chamber 20 and having a spray nozzle 22a for injecting fuel and an ignition plug 22b, a vane pump 28 connected to the burner assembly 22 through a fuel supply line 24 and supplying fuel by generating predetermined pressure, a blower fan 32 for blowing air towards the combustion chamber 20, and a drive motor 30 for rotating the blower fan 32.

The vane pump 28 is only an example of an air compression pump and other types of air compression pumps may be installed.

In addition, the hot air blower may include a control unit (not illustrated) for controlling the overall operation of the hot air blower, one pair of wheels 14 movably installed at the lower end of the hot air blower main body 10, a stopper 16 installed at the opposite side of the wheels 14, and a handle part 18 installed at the upper portion of the hot air blower main body 10.

The hot air blower as described above includes, as illustrated in FIG. 3a and FIG. 3b, a pressure regulating valve 40, which is installed at one side of the vane pump 28 so as to allow the air introduced through an air suction hole 10a to be supplied while being maintained at proper pressure, and the pressure regulating valve 40 is positioned on a path, through which the compressed air generated by the vane pump 28 moves to the burner assembly 22.

The opening pressure of the pressure regulating valve 40 is set such that the compressed air compressed by the vane pump 28 is supplied to the spray nozzle 22a of the burner assembly 22 at appropriate pressure.

Hereinafter, the structure of the hot air blower will be described in more detail.

First, the vane pump 28 includes a rotor 35 for rotating by the drive motor 30, a front housing 28d installed at one side of the rotor 35, and a rear housing 28e disposed to face the front housing 28d. The rotor 35 constitutes the compression part of the vane pump 28.

Furthermore, a chamber 37 through which air flows is formed between the front housing 28d and the rear housing 28e.

In addition, the front housing 28d and the rear housing 28e have isolation projections 28f, 28g formed towards the inside of the chamber 37, respectively. The one pair of isolation projections 28f, 28g are arranged in close contact with each other via a gasket 28h so as to divide the chamber 37 into the two parts of an introduction chamber 37a and a compression chamber 37b.

The rear housing 28e has the air suction hole 10a formed communicating with the introduction chamber 37a.

The introduction chamber 37a has a built-in filter 36 to filter out foreign matters contained in the passing air.

In addition, as illustrated in FIG. 3b, an introduction hole 28a is formed through the introduction chamber 37a side of the front housing 28d so that air passing through the filter 36 flows into the rotor 35.

In addition, a discharge hole 28b is formed through the compression chamber 37b side of the front housing 28d so that compressed air is discharged from the rotor 35 to the compression chamber 37b.

A filter 38 is also installed in the compression chamber 37b so as to filter foreign matters contained in the compressed air discharged through the discharge hole 28b.

At the periphery of the compression chamber 37b, an air line 28c is formed to transfer the compressed air to the burner assembly 22 side.

In addition, the rear housing 28e has a pressure regulating valve 40 or relief valve, for decompressing the compressed air discharged from the vane pump 28. The pressure regulating valve 40 is installed in a hole 42 formed in the rear housing 28e and the compressed air is discharged through the hole 42.

The air in the compression chamber 37b, which has been decompressed to a value set by the pressure regulating valve 40, is transferred to the burner assembly 22 side via the air line 28c.

A partition wall 28j is formed in the compression chamber 37b so as to separate the space in which the air line 28c is formed from the space in which the pressure regulating valve 40 is installed, and a relatively small through hole 39 is formed in the partition wall 28j. Accordingly, it is possible to prevent the air having a size greater than the set pressure from being discharged through the air line 28c.

In addition, a pressure gauge and plug 41 is installed at the through hole 39 side so as to close a pressure gauge port for measuring the pressure of the compressed air.

The pressure regulating valve 40 is installed in the hole 42 and includes a ball 43, a spring 44 and a pressure regulating screw 45.

Accordingly, when the pressure regulating screw 45 is tightened, the spring 44 is compressed and no displacement occurs even at high pressure, while when the pressure regulating screw 45 is loosened, the spring 44 extends and a displacement occurs even at low pressure.

Hereinafter, a process in which the compressed air compressed by the vane pump 28 is decompressed by means of the pressure control valve 40 and supplied to the spray nozzle 22a will be described.

The external air introduced through the air suction hole 10a in the hot air blower is introduced into the rotor 35 of the vane pump 28 through the filter 36 and the introduction hole 28a in the introduction chamber 37a, and the compressed air compressed by the rotor 35 is discharged through the discharge hole 28b and then moves to the compression chamber 37b by passing through an air filter 38.

As described above, the compressed air moved to the compression chamber 37b passes through the through hole 39 to the air line 28c and is supplied to the spray nozzle 22a of the burner assembly 22, during which the pressure of the compressed air discharged from the vane pump 28 is regulated by the pressure regulating valve 40 such that it is possible to supply uniform pressure to the spray nozzle 22a.

In addition, the fuel in the fuel tank 12 is sucked while the compressed air supplied to the spray nozzle 22a moves along the air line 28c and is thus supplied together with the compressed air to the spray nozzle 22a, wherein the suction amount of the fuel increases if the pressure of the compressed air is high while the suction amount of the fuel decreases if the pressure of the compressed air is low.

Accordingly, when the compressed air is supplied to the spray nozzle 22a at high pressure, the calorific value is increased, and when the compressed air is supplied at low pressure, the calorific value is decreased.

That is, the pressure of the compressed air discharged by the vane pump 28 is different for each hot air blower. For example, if the pressure regulating valve 40 is set to be opened at 7 psi, the pressure of the compressed air supplied to the spray nozzle 22a of the burner assembly 22 is uniformly decompressed to 7 psi and supplied to the spray nozzle 22a, even when the pressure of the compressed air supplied to the spray nozzle 22a of the burner assembly 22 is higher than 7 psi that is the set pressure.

For example, if the pressure of the compressed air discharged by the vane pump 28 installed in the hot air blower is 10 psi, the pressure regulating valve 40 is opened to allow the pressure of the compressed air in the compression chamber 37b to be decompressed to 7 psi and then to be supplied to the spray nozzle 22a, while if the pressure of the compressed air discharged by the vane pump 28 installed in another hot air blower is 9 psi, the pressure regulating valve 40 can also decompress the compressed air to 7 psi and supply the same to the spray nozzle 22a.

As described above, in the prior art, since the preset pressure is single, it is difficult for a user to regulate the pressure of the compressed air as necessary.

Of course, the pressure may be regulated by loosening or tightening the pressure regulating screw 45. However, the prior art has disadvantages in that it is difficult to easily adjust the pressure regulating screw 45 in the actual use of a hot air blower and thus it is not easy to control the calorific value.

Prior art document 1 discloses a hot air blower, which can regulate the air pressure to lower pressure by additionally including a low-pressure pressure regulating valve. However, it is difficult to adjust the air pressure to various fine values by the prior art low-pressure pressure regulating valve and thus the prior art has a disadvantage in that the air pressure may be adjusted to a single low pressure only, for example, 5 psi that is lower than a set high pressure, for example, 7 psi.

Prior Art Document Korean Reg. Patent Publication No. 10-0864804 (16 Oct. 2008)

### SUMMARY OF THE INVENTION

### Technical Problem

The present invention has been made to solve the problems of the prior art as described above and has an objective to provide a hot air blower that can finely control the amount of heat generated in the hot air blower by finely regulating the pressure of compressed air.

### Technical Solution

In order to accomplish the above objective, a hot air blower according to the present invention comprises:

a fuel tank, in which fuel is stored; an air compression pump for sucking and compressing air;

a pressure regulating valve installed at the air compression pump so as to decompress compressed air;

a burner assembly for receiving the fuel from the fuel tank and the air from the air compression pump; and

a combustion chamber for receiving the fuel from the burner assembly so as to combust the fuel,

wherein the pressure regulating valve is composed of a high-pressure pressure regulating valve and a low-pressure pressure regulating valve,

the low-pressure pressure regulating valve is provided with a low pressure valve opening and closing unit, and

the low pressure valve opening and closing unit includes:

a valve body installed communicating with a low pressure discharge port and having an inlet formed in the center of the front portion thereof so as to communicate with the low pressure discharge port, an outlet formed in the side surface thereof and communicating with the inlet, and an accommodation hole formed therein and communicating with both the inlet and the outlet;

a screw valve piece having a part extending back and forth while being accommodated in the accommodation hole, a front end disposed facing the inlet, and the side surface disposed to be spaced apart from the outlet while facing the outlet, the screw valve piece being spirally coupled to the valve body so as to move linearly by rotation; and

a valve knob coupled to the other end of the screw valve piece.

The screw valve piece includes:

an opening and closing piece having a convexly curved surface;

a movement piece having a spiral portion formed on the outer circumferential surface thereof so as to be screw-coupled to the spiral portion formed on the inner surface of the valve body; and

a support piece extending backwards from the movement piece so as to be engaged with the valve knob.

Each of the opening and closing piece and the movement piece has a circular front cross-sectional shape, and the diameter of the movement piece is formed to be larger than the diameter of the opening and closing piece.

The diameter of the movement piece of the screw valve piece is formed to be larger than the diameter of the support piece such that a stepped portion is formed, a valve cap is screw-coupled from the outside to the coupling portion of the valve body screw-coupled to the periphery of the movement piece, the rear portion of the valve cap is bent towards the center such that a through hole is formed, and the diameter of the through hole is formed to be smaller than the diameter of the movement piece.

### Effect of the Invention

According to the present invention structured as described above, the pressure regulation can be selectively made by the high-pressure pressure regulating valve and the low-pressure pressure regulating valve, of which opening pressure is adjusted differently, thereby facilitating the control of the calorific value and increasing the efficiency of the hot air blower.

Also according to the invention, there is the advantage that the pressure of the compressed air can be finely regulated through the fine movement of the screw valve piece in the forward and backward directions, since the valve body is provided to be installed communicating with the low pressure discharge port such that the inlet is formed in the center of the front portion thereof so as to communicate with the low pressure discharge port, the outlet is formed in the side surface thereof and communicating with the inlet, and the accommodation hole is formed therein and communicating with both the inlet and the outlet, and the screw valve piece is provided such that a part thereof extends back and forth while being accommodated in the accommodation hole, the front end thereof is disposed facing the inlet, and the side surface thereof is disposed to be spaced apart from the outlet while facing the outlet, the screw valve piece being to be spirally coupled to the valve body so as to move linearly by rotation.

Furthermore, according to the invention, there is the advantage that it is possible to prevent the screw valve piece from being arbitrarily separated backwards, since the diameter of the movement piece of the screw valve piece is formed to be larger than the diameter of the support piece such that the stepped portion is formed, the valve cap is screw-coupled from the outside to the coupling portion of the valve body screw-coupled to the periphery of the movement piece, the rear portion of the valve cap is bent towards the center such that the through hole is formed, and the diameter of the through hole is formed to be smaller than the diameter of the movement piece.

### BRIEF DESCRIPTION OF DRAWINGS

FIG. 1 is a front view showing a conventional hot air blower.

FIG. 2 is a plan view showing the conventional hot air blower.

FIG. 3a is a perspective view illustrating a conventional pressure regulating valve.

FIG. 3b is a cross-sectional view of FIG. 3a.

FIG. 4 is a partially taken perspective view illustrating a hot air blower according to the present invention.

FIG. 5 is a partially exploded perspective view of FIG. 4.

FIG. 6a is a front perspective view showing the structure of a low pressure valve opening and closing unit according to the present invention.

FIG. 6b is a rear perspective view showing the structure of the low pressure valve opening and closing unit according to the present invention.

FIG. 7 is a perspective view showing the installation structure of a high-pressure pressure regulating valve and a low-pressure pressure regulating valve in the present invention.

FIG. 8 is a longitudinal sectional view showing a state, in which the low pressure valve opening and closing unit is closed, in the hot air blower according to the present invention, and

FIG. 9 is a longitudinal sectional view showing a state, in which a low pressure valve opening and closing unit is opened, in the hot air blower according to the present invention.

### DETAILED DESCRIPTION FOR CARRYING OUT THE INVENTION

Hereinafter, embodiments of the present invention will be described in detail with reference to the accompanying drawings.

Herein, the same components as those in the prior art are denoted by the same reference numerals, and further description thereof will be omitted.

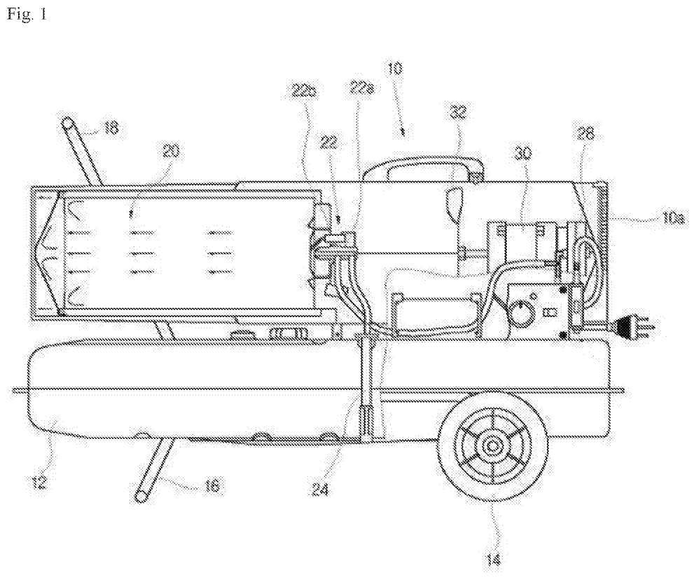

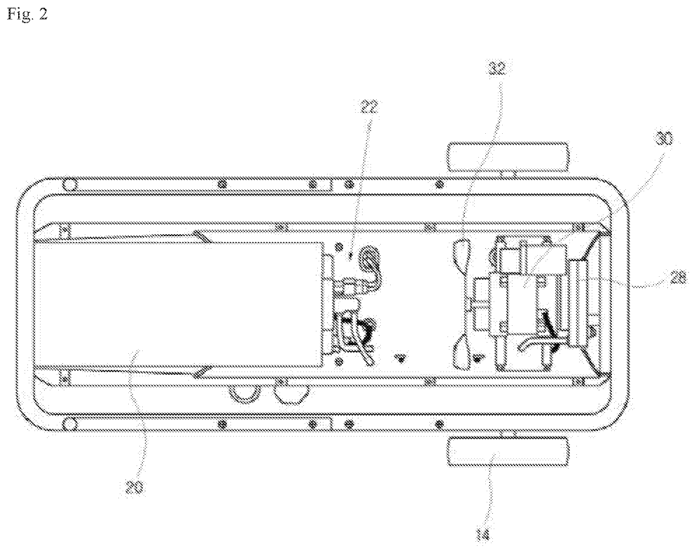

As illustrated in FIG. 1 to FIG. 3, a hot air blower of the present embodiment includes, as in the prior art, a hot air blower main body 10 having a fuel tank 12 provided in the lower portion, a combustion chamber 20 provided in the front portion of the hot air blower main body 10 at the upper portion of the fuel tank 12, a burner assembly 22 installed at the rear portion of the combustion chamber 20 and having a spray nozzle 22a for injecting fuel and an ignition plug 22b, a vane pump 28 connected to the burner assembly 22 through a fuel supply line 24 and supplying the fuel by generating predetermined pressure, a blower fan 32 for blowing air towards the combustion chamber 20, and a drive motor 30 for rotating the blower fan 32.

Herein, the relative positions of the fuel tank 12, the hot air blower main body 10, the combustion chamber 20, the burner assembly 22, the vane pump 28, and the drive motor 30 may be of course changed as necessary.

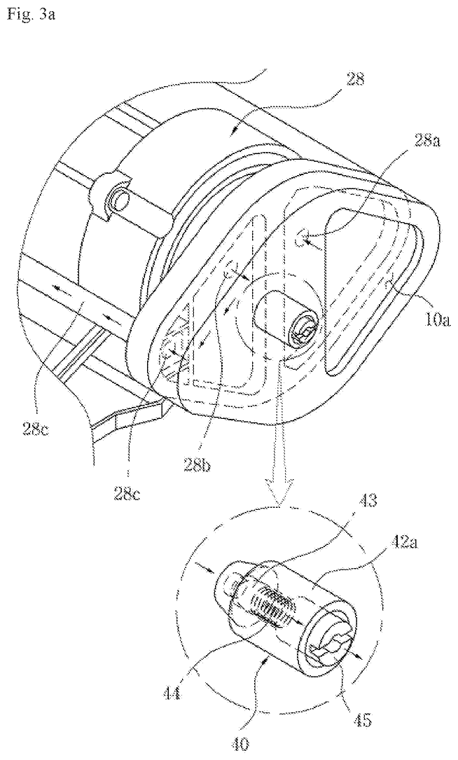

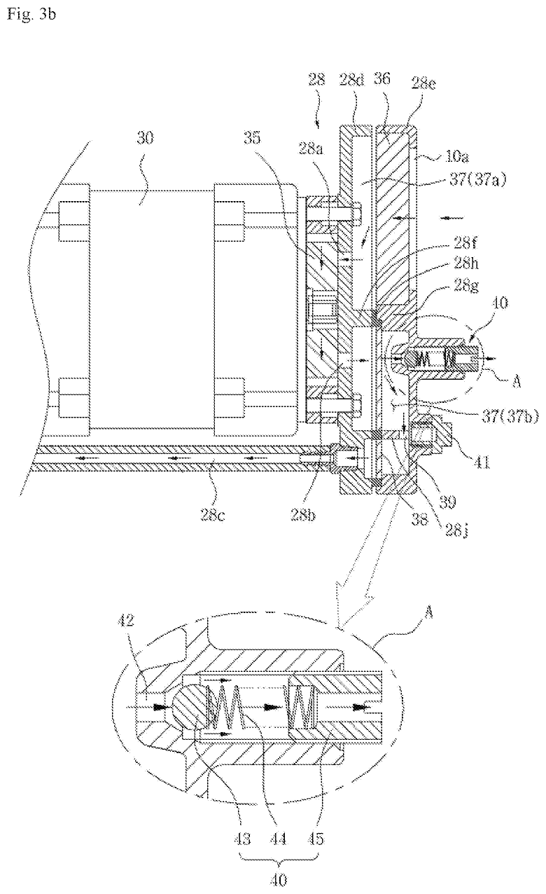

The vane pump 28 includes a rotor 35 rotating by the drive motor 30, a front housing 28d installed at one side of the rotor 35, and a rear housing 28e disposed facing the front housing 28d. The rotor 35 constitutes the compression part of the vane pump 28 (see FIG. 3a and FIG. 3b).

Furthermore, a chamber 37 through which air flows is formed between the front housing 28d and the rear housing 28e.

In addition, the front housing 28d and the rear housing 28e have isolation projections 28f, 28g formed towards the inside of the chamber 37, respectively. The one pair of isolation projections 28f, 28g are arranged in close contact with each other via a gasket 28h so as to divide the chamber 37 into the two parts of an introduction chamber 37a and a compression chamber 37b.

The rear housing 28e has an air suction hole 10a formed therein and communicating with the introduction chamber 37a.

In addition, an introduction hole 28a is formed through the introduction chamber 37a side of the front housing 28d so that air passing through the filter 36 flows into the rotor 35.

In addition, a discharge hole 28b is formed through the compression chamber 37b side of the front housing 28d so that compressed air is discharged from the rotor 35 to the compression chamber 37b.

A filter 38 is also installed in the compression chamber 37b so as to filter foreign matters contained in the compressed air discharged through the discharge hole 28b.

At the periphery of the compression chamber 37b, an air line 28c is formed to transfer the compressed air to the burner assembly 22 side.

Herein, the filters 36, 38 are optional components and need not necessarily be adopted.

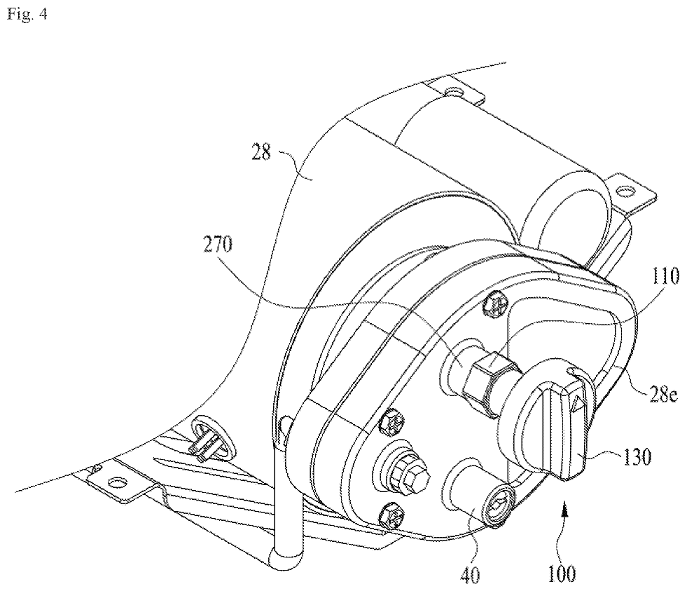

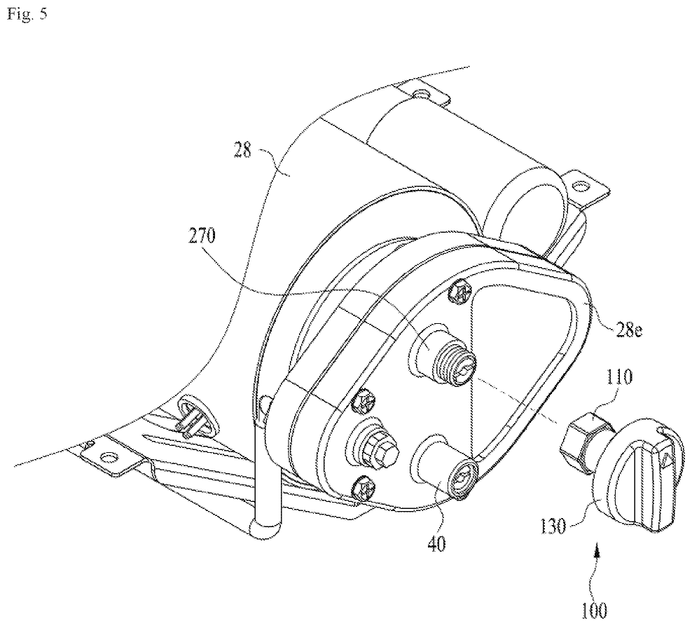

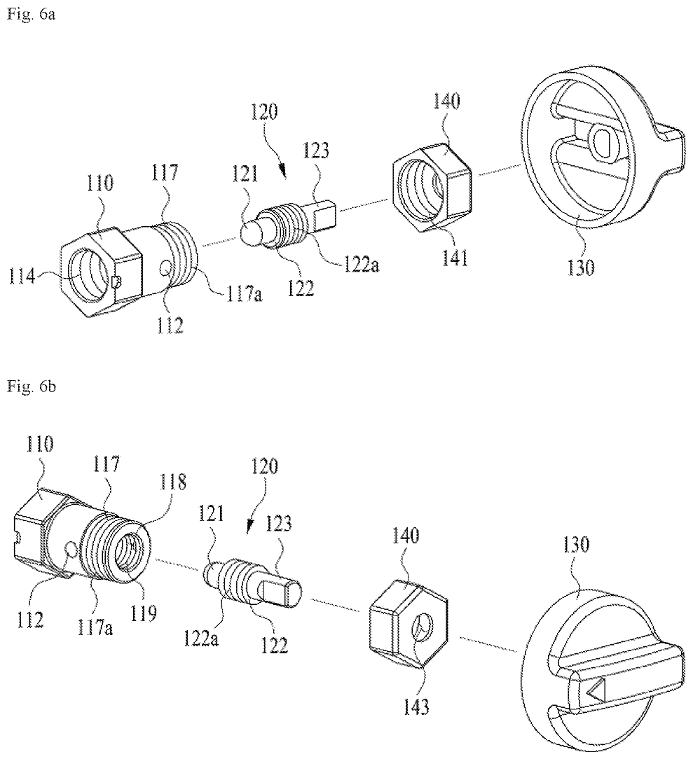

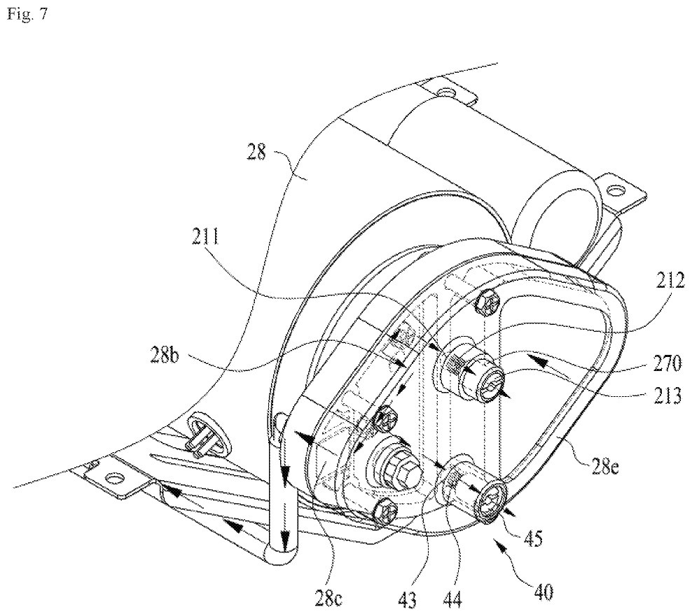

As illustrated in FIG. 4 to FIG. 9, in the hot air blower of the present invention, a high-pressure pressure regulating valve 40 and a low-pressure pressure regulating valve 200 are arranged at the compression chamber 37b side of the rear housing 28e and a low pressure valve opening and closing unit 100 is installed as a low pressure valve opening and closing unit at the low-pressure pressure regulating valve 200 so as to control the opening and closing of the low-pressure pressure regulating valve 200.

Herein, the high-pressure pressure regulating valve 40 is set to be opened when high pressure is applied, and the low-pressure pressure regulating valve 200 is set to be opened at pressure lower than that of the high-pressure pressure regulating valve 40.

Meanwhile, since the high-pressure pressure regulating valve 40 has already been described in the prior art, duplicated description thereof will be omitted.

Similar to the high-pressure pressure regulating valve 40, the low-pressure pressure regulating valve 200 includes a discharge port 270 formed in the rear housing 28e, a ball 211 installed to open or close the discharge port 270, a spring 212 for elastically supporting the ball 211, and a pressure regulating screw 213 fastened to the discharge port 270.

Accordingly, it is possible to set predetermined compressed air discharge pressure by adjusting the insertion length of the pressure regulating screw 213 and the compression length of the spring 212.

However, it is difficult to adjust the pressure regulating screw 213 during operation.

Hereinafter, referring to FIG. 4 to FIG. 9, the low pressure valve opening and closing unit 100 will be described in more detail.

As illustrated in FIG. 4 to FIG. 7, the low pressure valve opening and closing unit 100 may include a valve body 110, which is coupled to a low pressure discharge port 270 through a spiral portion 114 or the like and installed communicating with the low pressure discharge port 270 and has an inlet 111 formed in the center of the front portion thereof so as to communicate with the low pressure discharge port 270, an outlet 112 formed in the side surface thereof and communicating with the inlet 111, and an accommodation hole 113 formed therein and communicating with both the inlet 111 and the outlet 112, a screw valve piece 120, which has a part extending back and forth while being accommodated in the accommodation hole 113, a front end disposed facing the inlet 111, and the side surface disposed to be spaced apart from the outlet 112 while facing the outlet 112, the screw valve piece 120 being spirally coupled to the valve body 110 so as to move linearly by rotation, and a valve knob 130, which is coupled to the other end of the screw valve piece 120.

Accordingly, when the valve knob 130 is reciprocally rotated, the screw valve piece 120 connected to the valve knob 130 screwed on the valve body 110 such that the screw valve piece 120 reciprocates.

Specifically, the screw valve piece 120 includes an opening and closing piece 121 having a convexly curved surface, a movement piece 122 having a spiral portion 122a formed on the outer circumferential surface thereof so as to be screw-coupled to the spiral portion 119 formed on the inner surface of the valve body 110, and a support piece 123 extending backwards from the movement piece 122 so as to be engaged with the valve knob 130, wherein the spiral portion 122a formed on the outer circumferential surface of the movement piece 122 is screw-coupled to the spiral portion 119 formed on the inner circumferential surface of the coupling portion 117 of the valve body 110 such that relative movement can be carried out.

Particularly, when the screw valve piece 120 moves away from the inlet 111 by moving in the opposite direction of the low-pressure pressure regulating valve 200, compressed air is introduced through the inlet 111 and discharged through the outlet 112, so that the pressure regulation of low pressure can be carried out.

Each of the opening and closing piece 121 and the movement piece 122 has a circular front cross-sectional shape, wherein it is preferable that the diameter of the movement piece 122 is formed to be larger than the diameter of the opening and closing piece 121.

Accordingly, the compressed air is discharged through the inlet 111 and outlet 112 of the valve body 110 but not through the coupling hole 118 at the rear side of the valve body 110, to which the screw valve piece 120 is coupled.

In addition, the diameter of the movement piece 122 of the screw valve piece 120 is formed to be larger than the diameter of the support piece 123 such that a stepped portion 126 is formed, wherein on the coupling portion 117 of the valve body 110 screw-coupled to the periphery of the movement piece 122, a screw portion 141 formed on the inner circumferential surface of the valve cap 140 firmly supports the outside of the coupling portion 117 of the valve body 110, on which a screw portion 117a is formed.

Particularly, the rear portion of the valve cap 140 is bent towards the center thereof so as to form a through hole 143, wherein it is possible to prevent the screw valve piece 120 from being arbitrarily separated backwards by forming the diameter of the through hole 143 smaller than the diameter of the movement piece 122.

That is, the support piece 123 of the screw valve piece 120 is form to continuously pass through the coupling hole 118 of the valve body 110 and the through hole 143 of the valve cap 140.

As described hereinabove, the low pressure and calorific value of the compressed air can be finely regulated by the high-pressure pressure regulating valve 40, the low-pressure pressure regulating valve 200, and the low pressure valve opening and closing unit 100.

Specifically, the high-pressure pressure regulating valve 40 and the low-pressure pressure regulating valve 200 are each set to be opened at different pressure.

For example, in this embodiment, it is possible to set the high-pressure pressure regulating valve 40 to be opened when the pressure of the compressed air is greater than 7 psi, and the low-pressure pressure regulating valve 200 to be opened when the pressure of the compressed air is greater than 5 psi.

However, although the low-pressure pressure regulating valve 200 is opened when the pressure of the compressed air is 5 psi or higher, since the amount of opening by the low pressure valve opening and closing unit 100 can be controlled, the pressure supplied to the spray nozzle 22a of the burner assembly 22 is not simply fixed to 5 psi but can be freely regulated at pressure between 5 psi and 7 psi.

Hereinafter, the operations of the hot air blower according to the present invention will be described in more detail.

First, as the hot air blower 10 including the high-pressure pressure regulating valve 40 and the low-pressure pressure regulating valve 200 respectively set to different pressure values is operated, the air introduced through the air suction hole 10a is introduced into the vane pump 28 through the introduction hole 28a so as to be compressed in the vane pump 28 and the compressed air discharged from the vane pump 28 sucks the fuel stored in the fuel tank 20 so as to be supplied together while moving to the spray nozzle 22a of the burner assembly 22 along the compression chamber 37b and the air line 28c.

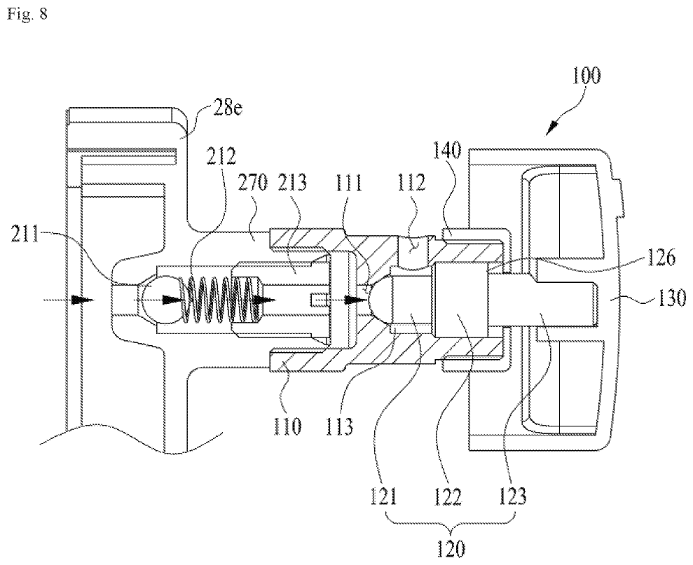

Herein, as shown in FIG. 8, if the low pressure valve opening and closing unit 100 is set to close the discharge port 110 of the low-pressure pressure regulating valve 200, that is, if the screw valve piece 120 is moved so that the opening and closing piece 121 comes into contact with and closes the inlet 111, when the compressed air of 10 psi is discharged to the compression chamber 37b by the vane pump 28, the high-pressure pressure regulating valve 40 set to 7 psi is opened such that the compressed air is uniformly supplied at 7 psi to the spray nozzle 22a.

Accordingly, the compressed air discharged from vane pump 28 is discharged through the high-pressure pressure regulating valve 40 and the spray nozzle 22a is supplied with the compressed air of 7 psi.

The fuel of the fuel tank 20 is supplied and combusted by the pressure of the compressed air supplied as described above, thereby providing a calorific value of high temperature.

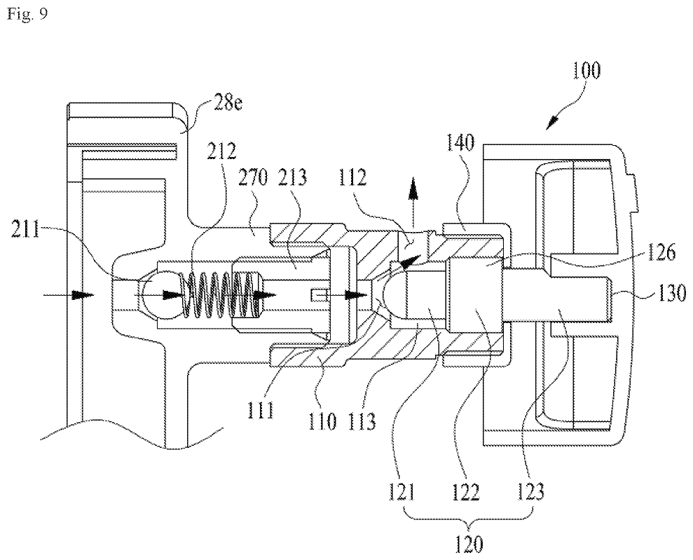

Meanwhile, as illustrated in FIG. 9, in order to reduce the calorific value as the temperature of a space sufficiently rises, if the discharge port 110 of the low-pressure pressure regulating valve 200 is opened by rotating the low pressure valve opening and closing unit 100, the low-pressure pressure regulating valve 200 set to 5 psi is opened and the compressed air in the compression chamber 37b is decompressed and transferred to the spray nozzle 22a of the burner assembly 22.

However, since the pressure does not fall directly to 5 psi and the amount of opening by the low pressure valve opening and closing unit 100 can be controlled, the pressure of the compressed air may be finely regulated, for example, the compressed air may be supplied at 6.5 psi when the amount of opening is small and may be supplied at 6.0 psi, 5.7 psi, 5.5 psi, or the like.

That is, when a user holds and turns the valve knob 130 in order to lower the calorific value of the hot air blower, the screw valve piece 120 connected to the valve knob 130 rotates along the spiral portion 119 formed on the valve body 110 so that the screw valve piece 120 reciprocates and thus the opening degree of the inlet 111 changes finely and accordingly the pressure of the compressed air is also finely regulated arbitrarily.

Therefore, according to the present invention, the calorific value by the hot air blower 100 can also be arbitrarily regulated to be high or low.

Thus, as the valve knob 130 is rotated, the screw valve piece 120 opens the inlet 111 while reciprocating and, accordingly, in the low-pressure pressure regulating valve 200, the ball 211 and the spring 212 of the discharge port 270 are pushed such that the discharge part 270 is opened and the compressed air is discharged, wherein the discharged compressed air is discharged to the outside of the low pressure valve opening and closing unit 100 through outlet 112 of the valve main body 130.

The embodiments of the present invention are merely exemplary, and those skilled in the art will appreciate that various modifications and equivalent other embodiments could be made within the scope of the following claims.

What is claimed is:

1. A hot air blower, comprising:
a fuel tank, in which fuel is stored;
an air compression pump for sucking and compressing air;
a pressure regulating valve installed at the air compression pump so as to decompress compressed air;
a burner assembly for receiving the fuel from the fuel tank and the air from the air compression pump; and
a combustion chamber for receiving the fuel from the burner assembly so as to combust the fuel,
wherein the pressure regulating valve is composed of a high-pressure pressure regulating valve and a low-pressure pressure regulating valve,
the low-pressure pressure regulating valve is provided with a low pressure valve opening and closing unit, and
the low pressure valve opening and closing unit includes:
a valve body installed communicating with a low pressure discharge port and having an inlet formed in the center of the front portion thereof so as to communicate with the low pressure discharge port, an outlet formed in the side surface thereof and communicating with the inlet, and an accommodation hole formed therein and communicating with both the inlet and the outlet;
a screw valve piece having a part extending back and forth while being accommodated in the accommodation hole, a front end disposed facing the inlet, and the side surface disposed to be spaced apart from the outlet while facing the outlet, the screw valve piece being spirally coupled to the valve body so as to move linearly by rotation; and
a valve knob coupled to the other end of the screw valve piece.

2. A hot air blower according to claim 1, wherein
the screw valve piece includes:
an opening and closing piece having a convexly curved surface;
a movement piece having a spiral portion formed on the outer circumferential surface thereof so as to be screw-coupled to the spiral portion formed on the inner surface of the valve body; and
a support piece extending backwards from the movement piece so as to be engaged with the valve knob.

3. A hot air blower according to claim 2, wherein each of the opening and closing piece and the movement piece has a circular front cross-sectional shape, and the diameter of the movement piece is formed to be larger than the diameter of the opening and closing piece.

4. A hot air blower according to claim 2, wherein the diameter of the movement piece of the screw valve piece is formed to be larger than the diameter of the support piece such that a stepped portion is formed, a valve cap is screw-coupled from the outside to the coupling portion of the valve body screw-coupled to the periphery of the movement piece, the rear portion of the valve cap is bent towards the center such that a through hole is formed, and the diameter of the through hole is formed to be smaller than the diameter of the movement piece.
